(19) United States
(12) Patent Application Publication
(10) Pub. No.: US 2009/0059151 A1
(43) Pub. Date: Mar. 5, 2009

(54) Liquid crystal display panel and manufacturintg method therreof

(75) Inventors: Jong-Seong Kim, Pohang-si (KR); Saran Neerja, Suwon-si (KR); Woo-Jae Lee, Yongin-si (KR); Seong-Sik Shin, Seongnam-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 12/154,181

(22) Filed: May 20, 2008

(30) Foreign Application Priority Data
Sep. 3, 2007 (KR) 10-2007-0088849

(51) Int. Cl. G02F 1/1343; G02F 1/1341; H02G 3/04

(52) U.S. Cl. 349/139; 349/189; 174/68.1; 977/762

(57) ABSTRACT

Disclosed is a liquid crystal display panel and manufacturing method thereof. The liquid crystal display panel includes a thin film transistor substrate, an opposite substrate facing the thin film transistor substrate, a pixel electrode formed on the thin film transistor substrate, and a common electrode formed on the opposite substrate. At least one of the pixel electrode and the common electrode includes conductive nanowires and a conductive filler.

### CROSS REFERENCE TO RELATED APPLICATION

This application claims priority under 35 U.S.C. §119 to Korean Patent Application No. 10-2007-0088849, filed on Sep. 3, 2007 in the Korean Intellectual Property Office (KIPO), the contents of which is incorporated herein by reference in its entirety.

### BACKGROUND OF THE INVENTION

1. Field of the Invention

The present disclosure relates to a liquid crystal display (“LCD”) panel and, more particularly, to a pixel electrode formed on a thin film transistor (“TFT”) substrate and a common electrode formed on an opposite substrate and a method of manufacturing the same.

2. Discussion of the Related Art

Electronic equipment, such as cellular telephones, digital cameras, notebook computers, and monitors include display devices for displaying images. Various kinds of display devices may be used, but flat panel display devices are predominantly used. An LCD device, a typical flat panel display device, displays images by using electro-optical characteristics of a liquid crystal material.

An LCD display device typically includes an LCD panel to display images, a driving circuit to drive the LCD panel, and a backlight assembly to supply light to the LCD panel. An LCD panel also typically includes a TFT substrate and an opposite substrate on which a pixel electrode and a common electrode are formed, respectively.

Conventional pixel and common electrodes are generally made of indium tin oxide (“ITO”) or indium zinc oxide (“IZO”). The pixel and common electrodes need high transparency and low surface resistance for driving the device. The pixel and common electrodes are formed by at least one of electron vacuum deposition, physical vapor deposition, and sputtering deposition, thereby resulting in an increase in processing time and material costs. The material of the pixel and common electrodes has been developed for a long time. For example, conductive nanowires and carbon nanotube (CNT) have been developed as materials having characteristics similar ITO and IZO, including having high transparency and conductivity. The conductive nanowires and the CNT are formed in a bar shape and in a network structure so as to have conductivity. The conductivity of the unrefined CNT is lower than that of the ITO. The conductive nanowires may obtain lower surface resistance than that of the ITO according to concentration, and thus the conductive nanowires are applicable to the LCD panel. However, the surfaces of the pixel and common electrodes using the conductive nanowires are rugged because the conductive nanowires overlap each other. It is also difficult for the pixel and common electrodes to obtain a uniform electric field in a micro-size area.

### SUMMARY OF THE INVENTION

In one embodiment of the present invention, an LCD panel is provided that is capable of uniformly forming the surfaces of pixel and common electrodes by filling an empty space formed by conductive nanowires with a conductive filler.

In an exemplary embodiment, a liquid crystal display panel includes: a thin film transistor substrate; an opposite substrate facing the thin film transistor substrate; a pixel electrode formed on the thin film transistor substrate; and a common electrode formed on the opposite substrate, wherein at least one of the s pixel electrode and the common electrode includes conductive nanowires and a conductive filler.

In another exemplary embodiment, a method of manufacturing a liquid crystal display panel includes: providing a thin film transistor substrate on which a pixel electrode including conductive nanowires and a conductive filler is formed; providing an opposite substrate on which a common electrode is formed, the opposite substrate facing the thin film transistor substrate; and attaching the thin film transistor substrate to the opposite substrate and injecting liquid crystal molecules between the thin film transistor substrate and opposite substrate.

In another exemplary embodiment, a method of manufacturing a liquid crystal display panel includes: providing a thin film transistor substrate on which a pixel electrode is formed; providing an opposite substrate on which a common electrode including conductive nanowires and a conductive filler is formed, the opposite substrate facing the thin film transistor substrate; and attaching the thin film transistor substrate to the opposite substrate and injecting liquid crystal molecules between the thin film transistor substrate and opposite substrate.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 is a layout view of an LCD panel according to an exemplary embodiment of the present invention;

FIG. 2 is a cross-sectional view taken along line I-I′ of FIG. 1;

FIG. 3 shows a portion of a pixel electrode according to a first exemplary embodiment of the present invention;

FIG. 4 is enlarged plan view illustrating the conductive nanowires in FIG. 3;

FIG. 5 shows a portion of a pixel electrode according to a second exemplary embodiment of the present invention;

FIG. 6 is a cross-sectional view of an LCD panel according to another exemplary embodiment of the present invention;

FIG. 7 is a cross-sectional view illustrating a TFT array substrate forming process except for a pixel electrode in FIG. 2;

FIG. 8A to FIG. 8C are cross-sectional views illustrating a pixel electrode forming process according to a first exemplary embodiment of the present invention;

FIG. 9A and FIG. 9B are cross-sectional views illustrating a pixel electrode forming process according to a second exemplary embodiment of the present invention;

FIG. 10 is a cross-sectional view illustrating a portion of an opposite substrate forming process according to an exemplary embodiment of the present invention; and

FIG. 11 is a cross-sectional view illustrating a process for mating a TFT array substrate with an opposite substrate according to an exemplary embodiment of the present invention.

### DETAILED DESCRIPTION OF THE INVENTION

Exemplary embodiments of the present invention, examples of which are illustrated in the accompanying drawings, are below described in detail. Wherever s possible, the same reference numbers will be used throughout the drawings to refer to the same or like parts.

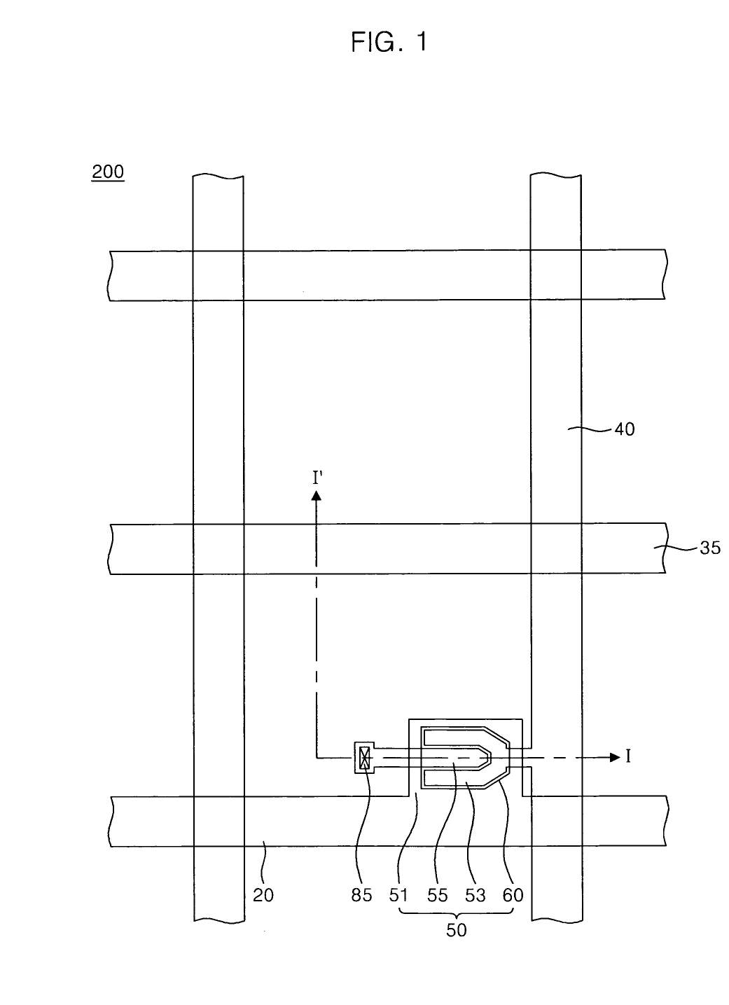

The exemplary embodiments of the present invention are described with reference to FIGS. 1 to 11 as follows.

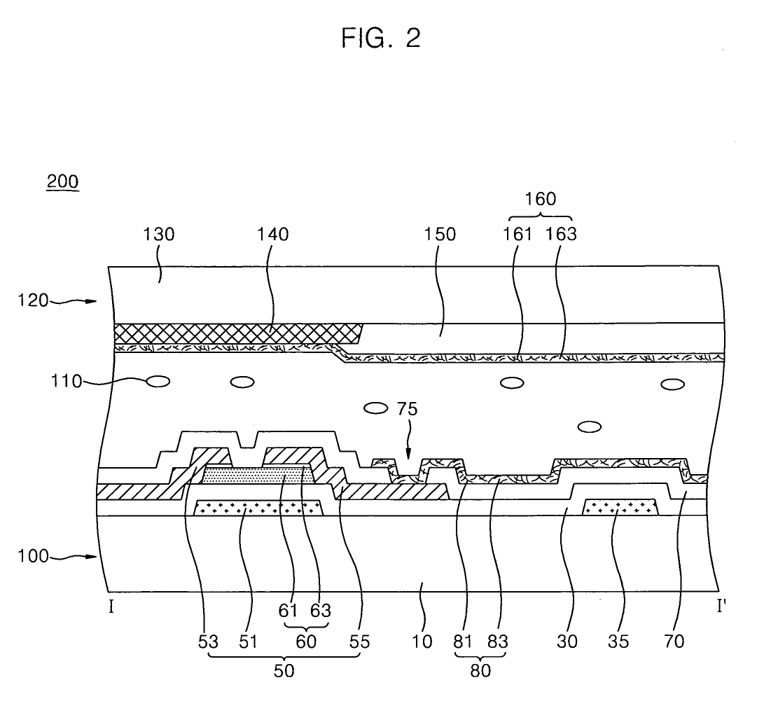

FIG. 1 is a layout view of an LCD panel according to an exemplary embodiment of the present invention, and FIG. 2 is a cross-sectional view taken along line I-I′ of FIG. 1.

Referring to FIG. 1 and FIG. 2, the LCD panel 200 includes a TFT substrate 100, an opposite substrate 120, and liquid crystal molecules 110.

The TFT substrate 100 includes a gate line 20, a storage line 35, a data line 40, a gate insulating layer 30, a TFT 50, a pixel electrode 80 and a protective layer 70.

The gate line 20 receives a scan signal from a gate driver. The gate line 20 is formed on a first substrate 10 and is formed of a signal layer or multiple layers including a metal material such as silver (Ag), aluminum (Al), chrome (Cr), or an alloy thereof.

The storage line 35 is formed parallel to the gate line 20 on the first substrate 10. The storage line 35 is formed of a material identical with that of the gate line 20.

The data line 40 receives a pixel voltage signal from a data driver. The data line 40 is perpendicularly formed to the gate line 20, with the gate insulating layer 30 disposed therebetween.

The gate insulating layer 30 is formed between the gate line 20 and the data line 40 and insulates a gate metal pattern including the gate line 20 and the storage line 35 from a data metal pattern including the data line 40.

The TFT 50 supplies the pixel voltage signal provided from the data line 40 to the pixel electrode 80 in response to the scan signal provided from the gate line 20. The TFT 50 includes a gate electrode connected to the gate line 20, a source electrode 53 connected to the data line 40, and a drain electrode 55 connected to the pixel electrode 80 and spaced apart from the source electrode 53. The TFT 50 also includes a semiconductor pattern 60 forming a channel between the source electrode 53 and the drain electrode 55. The semiconductor pattern 60 includes an active layer 61 and an ohmic contact layer 63. The active layer 61 overlaps the gate electrode 51 with the gate insulating layer 30 disposed therebetween. The ohmic contact layer 63 is formed on the active layer 61 to form ohmic contact with the source and drain electrodes 53 and 55.

The pixel electrode 80 is connected to the drain electrode 55 of the TFT 50. The pixel electrode 80 receives the pixel voltage signal from the TFT 50. The pixel electrode 80 includes first conductive nanowires 81 and a first conductive filler 83.

The protective layer 70 is formed on the data line 40 and the TFT 50 to cover the data line 40 and the TFT 50. The protective layer 70 has a contact hole 75 through which the pixel electrode 80 contacts a portion of the drain electrode 55.

The opposite substrate 120 includes a black matrix 140, a color filter 150, and a common electrode 160.

The black matrix 140 is arranged in matrix form on a second substrate 130 to define a region of the color filter 150. The black matrix 140 overlaps the gate and data lines 20 and 40 of the TFT substrate 100, and the TFT 50.

The color filter 150 is formed in a region defined by the black matrix 140. The color filter 150 includes red (“R”), green (“G”) and blue (“B”) color filters to display a predetermined color. An arrangement of the color filter 150 may be a stripe shape aligning the R, G, and B color filters in a line.

The common electrode 160 is formed on the black matrix 140 and the color filter 150. The common electrode 160 controls the orientation of the liquid crystal molecules 110 by a voltage difference with the pixel electrode 80 of the TFT substrate 100, thereby controlling light transmittance. The common electrode 160 includes second conductive nanowires 161 and a second conductive filler 163.

The liquid crystal molecules 110 are made of materials having dielectric anisotropy and refractive anisotropy. The liquid crystal molecules 110 are rotated by a difference between a pixel voltage supplied from the pixel electrode 80 of the TFT substrate 100 and a common voltage supplied from the common electrode 160 of the opposite substrate 120, thereby controlling the light transmittance.

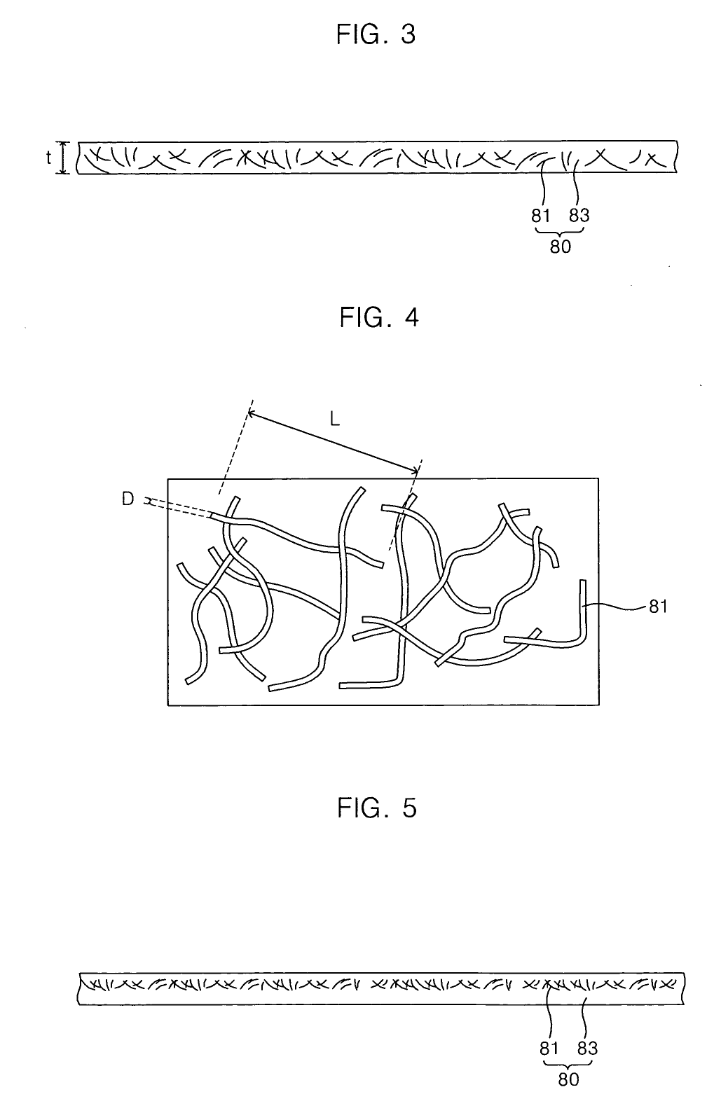

The pixel electrode 80 according to an exemplary embodiment of the present invention is more fully described below with reference to FIG. 3 to FIG. 5.

FIG. 3 shows the pixel electrode according to a first exemplary embodiment of the present invention and FIG. 4 is an enlarged view illustrating the conductive nanowires 81 shown in FIG. 3.

The pixel electrode 80 includes the first conductive nanowires 81 and the first conductive filler 83.

The first conductive nanowires 81 are electrically connected to each other and are have a polygon or closed curve shape. The first conductive nanowires 81 may be made of at least one selected from the group consisting of gold (“Au”), silver (“Ag”), platinum (“Pt”), palladium (“Pd”), nickel (“Ni”), cupper (“Cu”), carbon (“C”), aluminum (“Al”), tin (“Sn”), and titanic (“Ti”) or made of a compound thereof. Especially, the first conductive nanowires 81 may be made of Ag. As shown in FIG. 4, a diameter D of the first conductive nanowires 81 may be from about 20 nm to about 40 nm, and a length L of the first conductive nanowires 81 may be from about 5 μm to about 10 μm. Other diameters and lengths may be used.

The first conductive filler 83 fills an empty space between the first conductive nanowires 81, so that an electric field may uniformly flow. The first conductive filler 83 is made of a conductive polymer material or a transparent conductive ceramic material. For example, the conductive polymer material may be at least one selected from the group consisting of poly(p-phenylene), polypyrrole, poly(p-phenylene vinylene), polythiophene, poly(3,4-etylenedioxythiophene), poly(thienylenevinylene), and polyaniline. The transparent conductive ceramic material may be at least one of indium tin oxide (“ITO”), indium zinc oxide (“IZO”), and indium tin zinc oxide (“ITZO”). The first conductive filler 83 filling the empty space between the first conductive nanowires 81 planarizes the first conductive nanowires 81, thereby preventing pixel electrode 80 from having a rough surface.

As shown in FIG. 3, a thickness t of the first conductive filler 83 may be from about 10 nm to about 1 μm. When the thickness t of the first conductive filler 83 is thinner than about 10 nm, it is difficult to maintain sufficient conductivity. When the thickness t is greater than about 1 μm, the pixel electrode 80 is thickly formed.

FIG. 5 shows the pixel electrode according to a second exemplary embodiment of the present invention.

The pixel electrode includes the first conductive filler 83 and the first conductive nanowires 81.

The first conductive filler 83 is deposited onto a lower part of the pixel electrode 80. Namely, the first conductive filler 83 is formed below the first conductive nanowires 81 to distribute a stable and uniform electric field. The first conductive filler 83 may be made of a conductive polymer material or a transparent conductive ceramic material as described above.

The first conductive nanowires 81 are deposited on the first conductive filler 83. The first conductive nanowires 81 may be made of Ag.

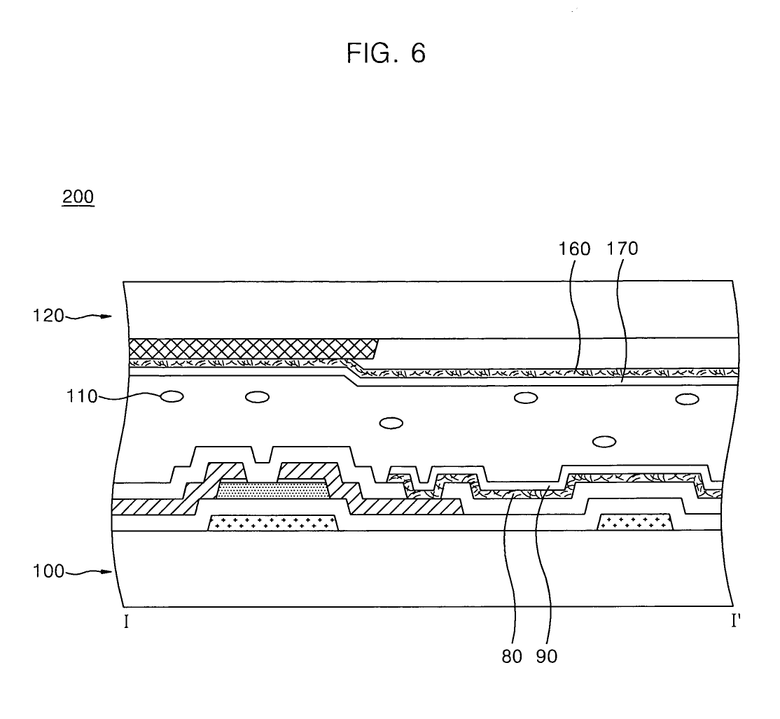

FIG. 6 is a cross-sectional view of an LCD panel according to another exemplary embodiment of the present invention.

The TFT substrate 100, the opposite substrate 120, and the liquid crystal molecules 110 of the LCD panel 200 in FIG. 6 have the same configuration as corresponding ones in FIG. 2, and therefore a detailed description is not repeated.

Unlike FIG. 2, the LCD panel 200 in FIG. 6 further includes first and second overcoat layers 90 and 170 on the pixel and common electrodes 80 and 160, respectively. The first and second overcoat layers 90 and 170 increase the adherence ability to the pixel and common electrodes 80 and 160, respectively.

The first and second overcoat layers 90 and 170 may be made of transparent synthetic resins. The transparent synthetic resins may be at least one selected from the group consisting of polymethly methacrylate (PMMA), polyamide (PA), polyurethane resin (PUR), polyehtersulfone resin (PES), polyethylene terephthalate (PET), and epoxy resin.

The first conductive nanowires 81 and the first conductive filler 83 may be used for an anti-static layer of a plane-to-line switching (“PLS”) mode and touch screen panel display panel as well as the pixel and common electrodes of the LCD panel.

The common electrode 160 of the opposite substrate 120 has the same configuration as the pixel electrode 80 of the TFT substrate 100, and therefore a detailed description thereof is not repeated. The color filter may be formed on the TFT substrate as well as the opposite substrate.

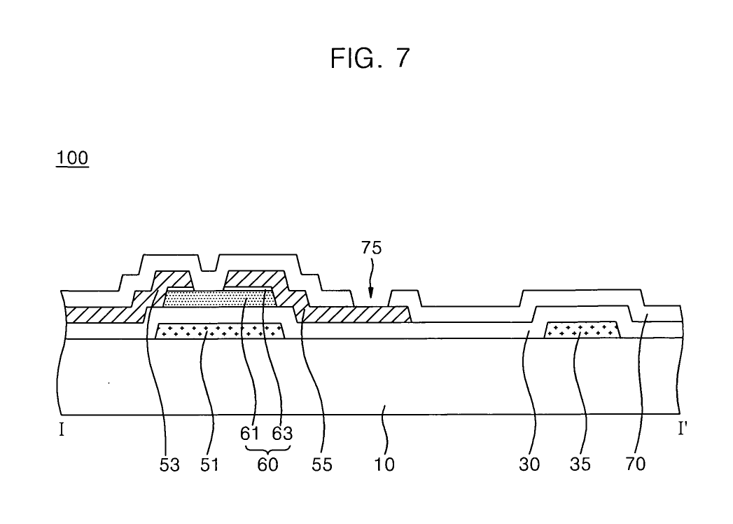

A manufacturing method of the LCD panel according to the exemplary embodiment of the present invention is described below with reference to FIG. 7 to FIG. 11.

FIG. 7 is a cross-sectional view illustrating a TFT substrate manufacturing process except for a pixel electrode in FIG. 2.

A TFT substrate 100 is prepared including a TFT array, except for the pixel electrode, formed on a first substrate 10. More specifically, a gate metal pattern including a gate line (not shown), a storage line 35 and a gate electrode 51 is formed on the first substrate 10. The gate insulating layer 30 is formed on the gate metal pattern. A semiconductor pattern 60 including an active layer 61 and an ohmic contact layer 63 is formed on the gate insulating layer 30. A data metal pattern including a data line (not shown), a source electrode 53, and a drain electrode 55 is formed on the gate insulating layer 30 and the semiconductor pattern 60. A protective layer 70 having a contact hole 75 is formed on the data metal pattern and the gate insulating layer 30.

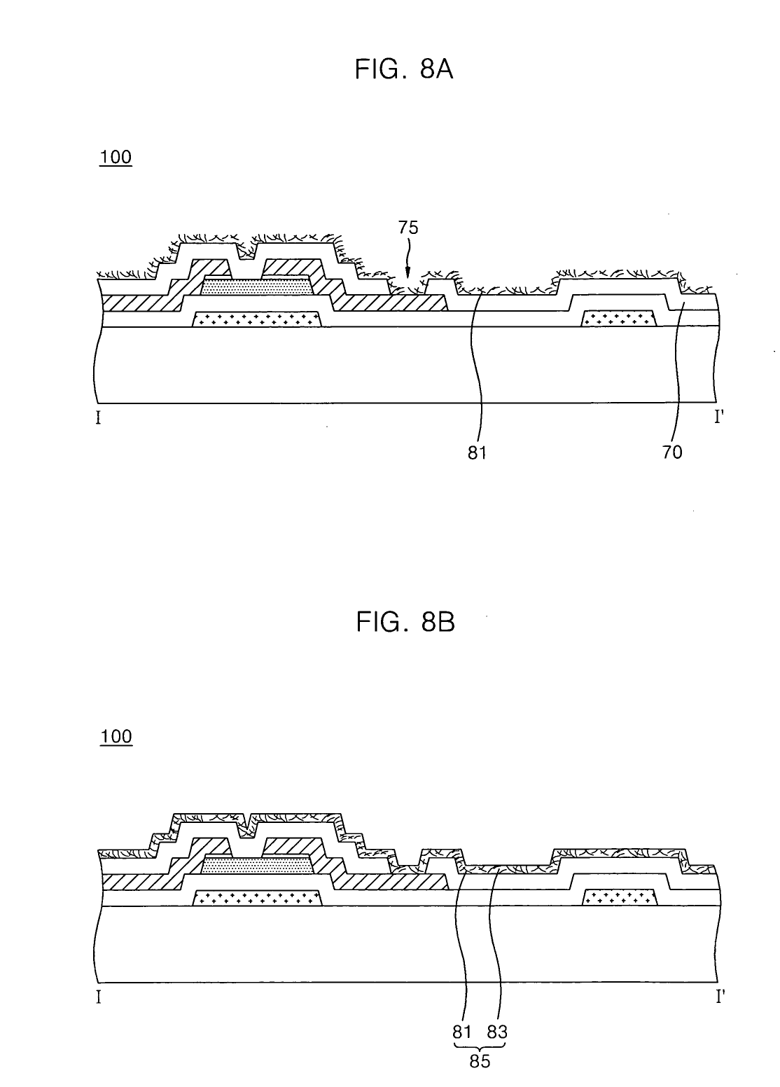

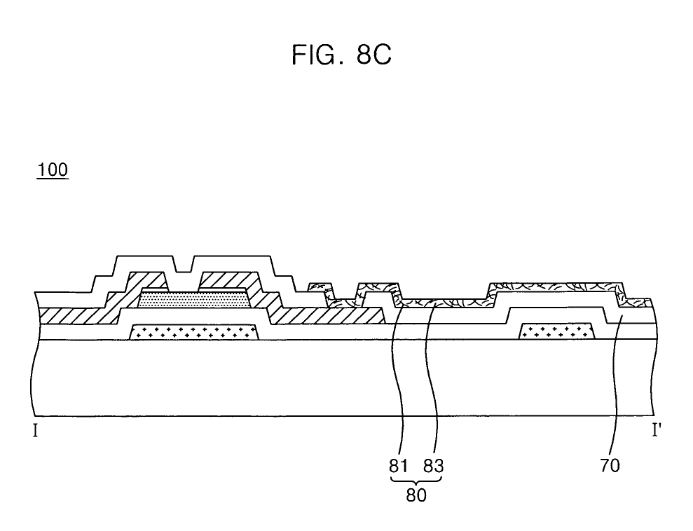

FIG. 8A to FIG. 8C are cross-sectional views illustrating a pixel electrode forming process according to a first exemplary embodiment of the present invention.

First conductive nanowires 81 are deposited on the protective layer 70 having the contact hole 75. The first conductive nanowires 81 are deposited by wet coating such as spin coating, bar coating, or slit coating, thereby forming a first conductive nanowire layer on the protective layer 70 having the contact hole 75. The first conductive nanowires 81 are made of at least one selected from the group consisting of Au, Ag, Pt, Pd, Ni, Cu, C, Al, Sn and Ti or made of compound thereof. Especially, the first conductive nanowires 81 may be made of Ag.

As shown in FIG. 8B, a first conductive filler 83 fills the first conductive nanowire layer.

The first conductive filler 83 is filled by a depositing method such as sputtering or chemical vacuum deposition or by a wet coating method such as spin coating, bar coating, or slit coating.

The first conductive filler 83 may be made of a conductive polymer material or a transparent conductive ceramic material. For example, the conductive polymer material may be made of at least one selected from the group consisting of poly(p-phenylene), polypyrrole, poly(p-phenylene vinylene), polythiophene, poly(3,4-etylenedioxythiophene), poly(thienylenevinylene), and polyaniline. The transparent conductive ceramic material may be ITO, IZO, or ITZO. The first conductive filler 83 fills the first conductive nanowire layer, thereby forming a pixel electrode layer 85.

As shown in FIG. 8C, a pixel electrode 80 is formed on the protective layer 70. For example, the pixel electrode layer 85 is patterned by well-known photoresist process and etching processes, thereby forming the pixel electrode 80 including the first conductive nanowires 81 and the first conductive filler 83 on the protective layer 70.

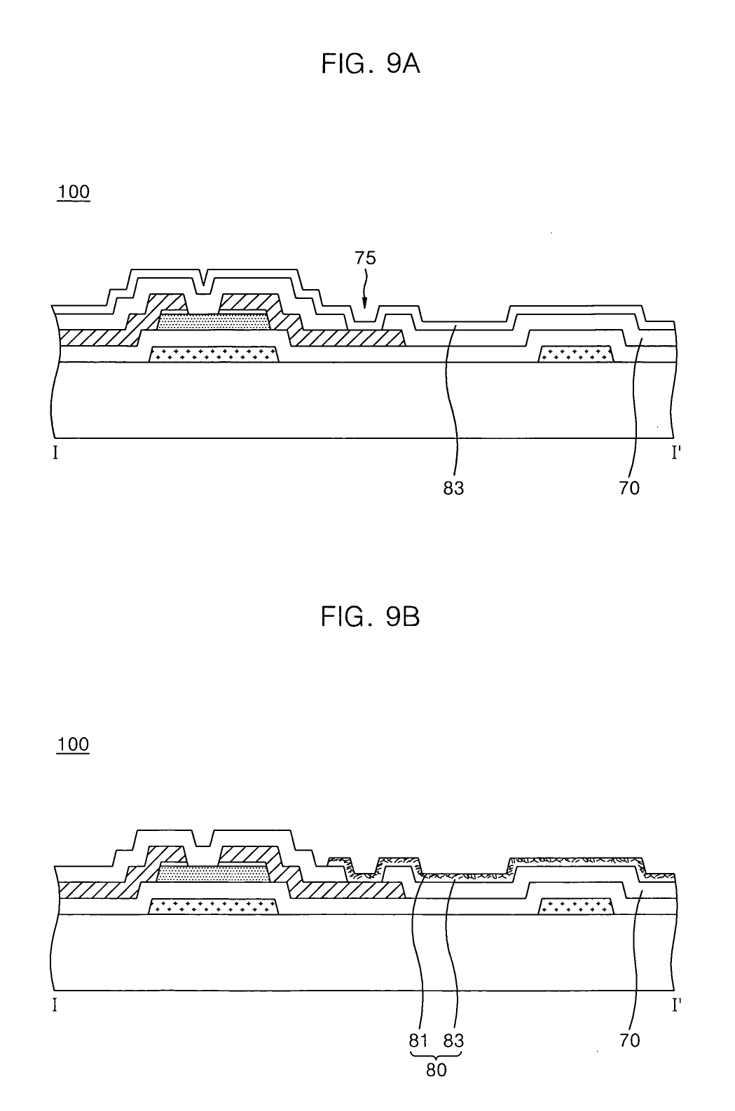

FIG. 9A and FIG. 9B are cross-sectional views illustrating a pixel electrode forming process according to a s econd exemplary embodiment of the present invention.

Referring to FIG. 9A, the first conductive filler 83 is deposited on the protective layer 70 having the contact hole 75. For example, the first conductive filler 83 may be deposited by a depositing method such as sputtering or chemical vacuum deposition or by a wet coating method such as spin coating, bar coating, or slit coating.

Referring to FIG. 9, the first conductive nanowires 81 are deposited on the first conductive filler 83. The first conductive nanowires 81 may be deposited by the wet coating. The first conductive filler 83 and the first conductive nanowires 81 form a pixel electrode layer (not shown). The pixel electrode layer is patterned, thereby forming the pixel electrode 80 including the first conductive nanowires 81 and the first conductive filler 83 on the protective layer 70.

Although not shown in FIG. 9B, a first overcoat layer such as overcoat layer 90 shown in FIG. 6 may be formed on the pixel electrode 80. For example, the first overcoat layer may be made of a transparent synthetic resin by wet coating such as spin coating, bar coating, or slit coating. The transparent synthetic resins may be made of any at least one selected from the group consisting of polymethly methacrylate (PMMA), polyamide (PA), polyurethane resin (PUR), polyehtersulfone resin (PES), polyethylene terephthalate (PET), and epoxy resin. The synthetic resin is hardened by using heat or ultraviolet (“UV”) rays and then is patterned by a photoresist process and an etching process, thereby forming the first overcoat layer on the pixel electrode 80.

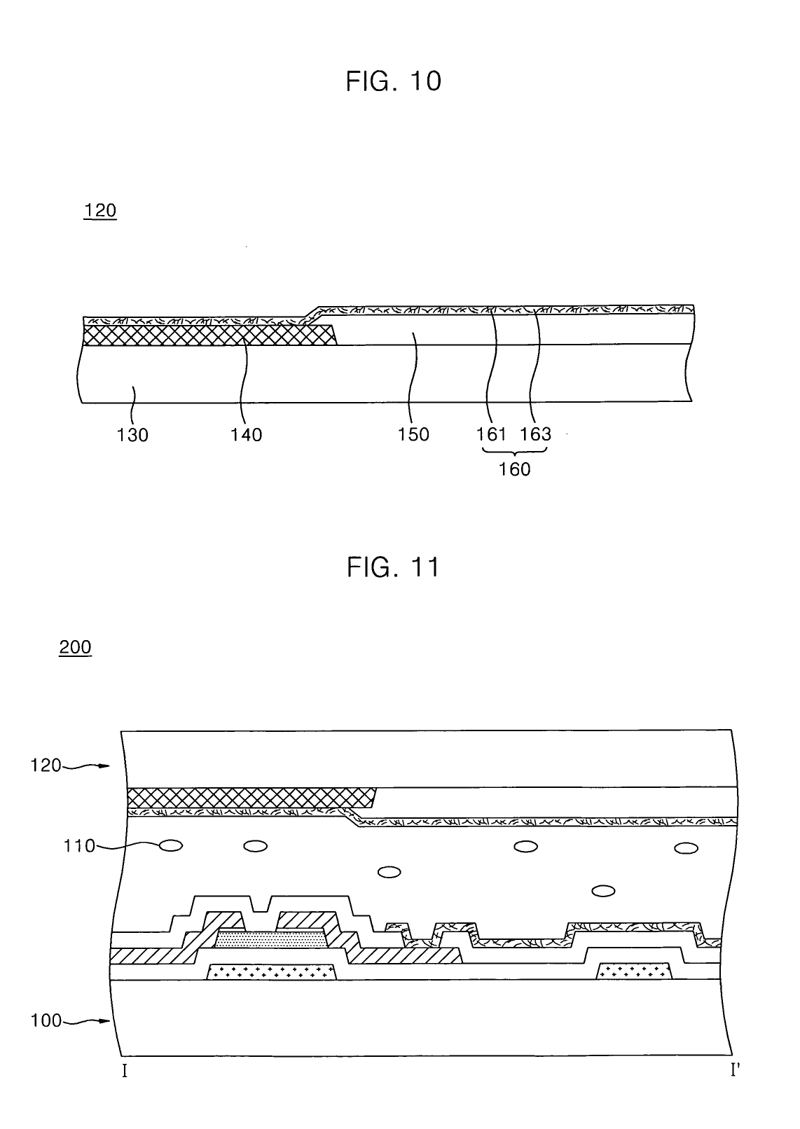

FIG. 10 is a cross-sectional view illustrating an opposite substrate forming process according to an exemplary embodiment of the present invention.

An opposite substrate 120 is prepared including a color filter array formed on a second substrate 130. More specifically, a black matrix 140 is formed on the second substrate 130 to define regions where a color filter 150 is to be formed. The color filter 150 is formed in a region defined by the black matrix 140. A common electrode 160 including second conductor nanowires 161 and a second conductor filler 163 is formed on the black matrix 140 and the color filter 150. The common electrode 160 is identically formed by the method as shown in FIG. 8A to FIG. 9B, and therefore a detailed description thereof is not repeated. A second overcoat layer (not shown) made of a transparent synthetic resin may be formed on the common electrode 160 to increase the adherence ability to the common electrode 160.

FIG. 11 is a cross-sectional view illustrating a process for mating the TFT array substrate with the opposite substrate according to an exemplary embodiment of the present invention.

Referring to FIG. 11, the TFT substrate 100 and the opposite substrate 120 are attached to each other, and the liquid crystal molecules 110 are injected between the substrates 100 and 120.

As described above, the LCD panel in accordance with the present invention forms the common and pixel electrodes filling the empty space between the conductive nanowires with the conductive filler. The conductive filler filling the empty space between the conductive nanowires prevents rugged surfaces of the pixel and common electrodes and planarizes the surfaces of those electrodes. Further, the overcoat layer is formed on the pixel and common electrodes, thereby increasing the adherence ability to the electrodes.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A liquid crystal display panel, comprising:
a thin film transistor substrate;
an opposite substrate facing the thin film transistor substrate;
a pixel electrode on the thin film transistor substrate; and
a common electrode on the opposite substrate,
wherein the pixel electrode or the common electrode includes conductive nanowires and a conductive filler.

2. The liquid crystal display panel of claim 1, wherein the conductive nanowires comprise at least one material selected from the group consisting of gold (Au), silver (Ag), platinum (Pt), palladium (Pd), nickel (Ni), cupper (Cu), carbon (C), aluminum (Al), tin (Sn), and titanic (Ti) or made of a material which is a compound thereof.

3. The liquid crystal display panel of claim 1, wherein the conductive filler is comprised of a conductive polymer material or a transparent conductive ceramic material.

4. The liquid crystal display panel of claim 3, wherein the conductive polymer material comprises at least one material selected from the group consisting of poly(p-phenylene), polypyrrole, poly(p-phenylene vinylene), polythiophene, poly(3,4-etylenedioxythiophene), poly(thienylenevinylene), and polyaniline.

5. The liquid crystal display panel of claim 3, wherein the transparent conductive ceramic material comprises at least one selected from the group consisting of indium tin oxide (ITO), indium zinc oxide (IZO), and indium tin zinc oxide (ITZO).

6. The liquid crystal display panel of claim 1, further comprising an overcoat layer on at least one of the pixel electrode and the common electrode.

7. The liquid crystal display panel of claim 6, the overcoat layer comprises transparent synthetic resins.

8. A method of manufacturing a liquid crystal display panel, the method comprising:
providing a thin film transistor substrate on which a pixel electrode comprising conductive nanowires and a conductive filler is formed;
providing an opposite substrate on which a common electrode is formed, the opposite substrate facing the thin film transistor substrate; and
attaching the thin film transistor substrate to the opposite substrate and injecting liquid crystal molecules between the thin film transistor substrate and opposite substrate.

9. The method of claim 8, wherein the pixel electrode is formed by;
forming a conductive nanowire layer by depositing the conductive nanowires on an area where the pixel electrode of the thin film transistor substrate is to be formed;
forming the pixel electrode layer by adding to the conductive nanowire layer a conductive filler; and
patterning the pixel electrode layer.

10. The method of claim 9, wherein the conductive filler is added by wet coating or vacuum deposition.

11. The method of claim 8, wherein the pixel electrode is formed by;
depositing the conductive filler on an area where the pixel electrode of the thin film transistor substrate is to be formed;
forming the pixel electrode layer by depositing the conductive nanowires on is the conductive filler; and
patterning the pixel electrode layer.

12. The method of claim 11, wherein the conductive filler is deposited by wet coating or vacuum deposition.

13. A method of manufacturing a liquid crystal display panel, the method comprising:
providing a thin film transistor substrate on which a pixel electrode is formed;
providing an opposite substrate on which a common electrode comprising conductive nanowires and a conductive filler is formed, the opposite substrate facing the thin film transistor substrate; and
attaching the thin film transistor substrate to the opposite substrate and injecting liquid crystal molecules between the thin film transistor substrate and opposite substrate.

14. The method of claim 13, wherein the common electrode is formed by;
forming a conductive nanowire layer by depositing the conductive nanowires on an area where the common electrode of the opposite substrate is to be formed;
forming the common electrode layer by adding to the conductive nanowire layer the conductive filler; and
patterning the common electrode layer.

15. The method of claim 14, wherein the conductive filler is added by wet coating or vacuum deposition.

16. The method of claim 13, wherein the common electrode is formed by;
depositing the conductive filler on an area where the common electrode of the opposite substrate is to be formed;
forming the common electrode layer by depositing the conductive nanowires on the conductive filler; and
patterning the common electrode layer.

17. The method of claim 16, wherein the conductive filler is deposited by wet coating or vacuum deposition.

18. The method of claim 13, further comprising an overcoat layer formed on the pixel electrode.

19. The method of claim 13, further comprising an overcoat layer formed on the common electrode.

20. A transparent electrode, comprising:
conductive nanowires comprising silver (Ag) and a conductive filler comprising a polymer material.
